(19) United States
(12) Patent Application Publication
(10) Pub. No.: US 2014/0165295 A1
(43) Pub. Date: Jun. 19, 2014

(54) ANTI-MICROBIAL LAUNDRY DETERGENT PRODUCT

(71) Applicant: The Procter & Gamble Company, Cincinnati, OH (US)

(72) Inventors: Yu GUO, Beijing (CN); Ryohei Ohtani, Nishinomiya (JP); Yoshiki Ishida, Osaka (JP); Hans Wendt, Beijing (CN); David Michael Eike, West Chester, OH (US)

(73) Assignee: The Procter & Gamble Company, Cincinnati, OH (US)

(21) Appl. No.: 14/103,872

(22) Filed: Dec. 12, 2013

(30) Foreign Application Priority Data
Dec. 13, 2012 (WO) CN2012/086574

(51) Int. Cl. C11D 3/48

(52) U.S. Cl. CPC C11D 3/48
USPC 8/137; 510/319; 206/459.5

(57) ABSTRACT

The use of a laundry detergent composition for providing an anti-microbial benefit. The laundry detergent composition comprises at least 2.9%, preferably from 3.2% to 30%, more preferably from 4.3% to 20%, by weight of the composition, of a linear alkylbenzene sulfonate (LAS), and the laundry detergent composition is capable of delivering a free LAS monomer level of more than 60 ppm, preferably from 67 ppm to 500 ppm, more preferably from 88 ppm to 300 ppm, in a laundry washing liquor.

### FIELD OF THE INVENTION

The present invention relates to the use of a laundry detergent composition for providing an anti-microbial benefit. The present invention also relates to a laundry detergent product comprising a laundry detergent composition contained within a container and a method of using the laundry detergent product to treat a fabric with an anti-microbial benefit.

### BACKGROUND OF THE INVENTION

Consumer products have evolved to address user needs for an anti-microbial benefit, in addition to their original intended functions. For example, an anti-microbial laundry detergent product is desired by users as it cleans fabrics whilst having an anti-microbial benefit on fabrics. Currently, the typical approach to deliver an anti-microbial benefit is the incorporation of anti-microbial agents into the consumer product formulations. Such anti-microbial agents either damage the bacteria envelope to kill bacteria, or denature the bacteria envelope to prevent bacteria growth or reproduction, thereby delivering the anti-microbial benefit.

However, the incorporation of anti-microbial agents into a consumer product leads to several challenges. Firstly, in terms of formulation design of a consumer product, some anti-microbial agents are not compatible or react with other ingredients (e.g., perfume oils) incorporated in the same formulation to cause a stability issue. Moreover, many consumer products comprising anti-microbial agents are harsh or irritating to the skin due to the nature of the chemicals utilized to provide the anti-microbial benefit.

Thus, there is a need for a laundry detergent product that provides an anti-microbial benefit without the need of incorporating an anti-microbial agent.

It is an advantage of the present invention to provide an anti-microbial laundry detergent product that is gentle to the skin.

It is a further advantage of the present invention to provide a stable anti-microbial laundry detergent product.

### SUMMARY OF THE INVENTION

In one aspect, the present invention is directed to the use of a laundry detergent composition for providing an anti-microbial benefit, the laundry detergent composition comprising at least 2.9%, preferably from 3.2% to 30%, more preferably from 4.3% to 20%, by weight of the composition, of a LAS, wherein the laundry detergent composition is capable of delivering a free LAS monomer level of more than 60 ppm, preferably from 67 ppm to 500 ppm, more preferably from 88 ppm to 300 ppm, in a laundry washing liquor.

In another aspect, the present invention is directed to a laundry detergent product comprising a laundry detergent composition contained in a container, wherein the laundry detergent composition comprises at least 2.9%, preferably from 3.2% to 30%, more preferably from 4.3% to 20%, by weight of the composition, of a linear alkylbenzene sulfonate (LAS), wherein the laundry detergent composition is capable of delivering a free LAS monomer level of more than 60 ppm, preferably from 67 ppm to 500 ppm, more preferably from 88 ppm to 300 ppm, in a laundry washing liquor, and wherein the container comprises instructions instructing the user of the anti-microbial benefit of the laundry detergent composition.

In yet another aspect, the present invention is directed to a method of using the laundry detergent product to treat a fabric with an anti-microbial benefit, comprising the step of administering from 5 g to 120 g of the laundry detergent composition into a laundry washing basin comprising water to form an aqueous solution, wherein the aqueous solution has a free LAS monomer level of more than 60 ppm, preferably from 67 ppm to 500 ppm, more preferably from 88 ppm to 300 ppm.

### DETAILED DESCRIPTION OF THE INVENTION

### Definitions

As used herein, the term “laundry detergent product” means a product relating to cleaning fabrics.

As used herein, the term “anti-microbial agent” refers to a chemical compound of which the principle intended function is to kill bacteria or to prevent their growth or reproduction. Those chemical compounds that do not have a principle intended function as anti-microbial agents but impart the anti-microbial benefit for some time are not considered as the anti-microbial agent of the present invention. For example, LAS in a laundry detergent composition is not considered as an anti-microbial agent because the principle intended function of LAS is a cleaning surfactant, even though it may impart an anti-microbial benefit in certain circumstances (as illustrated in the present invention).

As used herein, the term “free LAS monomer” refers to the linear alkylbenzene sulfonate (LAS) monomers that do not aggregate to form micelles. It is known that, LAS starts to form micelles when its concentration in water achieves or exceeds its critical micelle concentration (CMC). Thus, in a laundry washing liquor, LAS typically comprises those forming micelles and the left free LAS monomers. The free LAS monomer level in an aqueous solution can be calculated or measured by any method known in the prior art. Preferably, the free LAS monomer level is calculated by the Calculation Method of Free LAS Monomer as described hereinafter.

As used herein, the term “laundry washing liquor” refers to the typical amount of aqueous solution used for one cycle of laundry washing, preferably from 1 L to 50 L, alternatively from 1 L to 20 L for hand washing and from 20 L to 50 L for machine washing.

As used herein, the term “co-surfactant” refers to a coexistent surfactant in the laundry detergent composition of the present invention, in addition to the LAS. In one embodiment, the co-surfactant is selected from the group consisting of an anionic surfactant except the LAS (e.g., sulphated fatty alcohol ethoxylated (AES)), a cationic surfactant, a nonionic surfactant, a zwitterionic surfactant, and a combination thereof. A surfactant system is formed from the combination of the LAS and the co-surfactant.

As used herein, when a composition is “substantially free” of a specific ingredient, it is meant that the composition comprises less than a trace amount, alternatively less than 0.1%, alternatively less than 0.01%, alternatively less than 0.001%, by weight of the composition of the specific ingredient.

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

### Laundry Detergent Composition

The laundry detergent composition of the present invention comprises at least 2.9%, preferably from 3.2% to 30%, more preferably from 4.3% to 20%, by weight of the composition, of a LAS. In a laundry washing liquor, the laundry detergent composition is capable of delivering a free LAS monomer level of more than 60 ppm, preferably from 67 ppm to 500 ppm, more preferably from 88 ppm to 300 ppm.

In the present invention, applicant has surprisingly found that the level of the free LAS monomers in a laundry washing liquor constitutes the key to delivering an anti-microbial benefit. Only when the level of the free LAS monomers is above a specific level in a laundry washing liquor, is when an anti-microbial benefit is achieved. Specifically, a level of the free LAS monomers of more than 60 ppm in a laundry washing liquor provides a bacteria killing rate of at least 50% according to the QB/T 2738-2005 method. In one embodiment, a level of the free LAS monomers of more than 60 ppm in a laundry washing liquor having a temperature of above 35° C. provides a bacteria killing rate of at least 50% according to the QB/T 2738-2005 method. In an alternative embodiment, a level of the free LAS monomers of more than 67 ppm in a laundry washing liquor (e.g., at 25° C.) provides a bacteria killing rate of at least 50% according to the QB/T 2738-2005 method. Preferably, a level of the free LAS monomers of more than 88 ppm in a laundry washing liquor (e.g., at 25° C.) provides a bacteria killing rate of at least 90% according to the QB/T 2738-2005 method. Without wishing to be bound by theory, it is believed that a sufficient amount of the free LAS monomers in a laundry washing liquor (namely, more than 60 ppm, preferably more than 67 ppm, more preferably more than 88 ppm of the free LAS monomers in the laundry washing liquor) enables at least a portion of the free LAS monomers to penetrate into and damage the bacteria envelope, thereby achieving the anti-microbial benefit. Furthermore, laundry detergent compositions with such an anti-microbial benefit delight users by providing a fresh, treated fabric due to less amounts of bacteria left on the fabric.

The laundry detergent composition herein may be of any suitable temperature for washing fabrics, preferably the temperatures of the laundry washing liquor range from 5° C. to 60° C. Applicant has found that a higher temperature of the laundry washing liquor helps in the anti-microbial benefit, thereby enabling a lower level of the free LAS monomers to achieve the same anti-microbial efficacy. For example, in order to achieve a bacteria killing rate of at least 50% according to the QB/T 2738-2005 method, the level of the free LAS monomers in a laundry washing liquor having a temperature of 25° C. is required to be more than 67 ppm. Nevertheless, a free LAS monomer level of 60 ppm in a laundry washing liquor having a temperature of above 35° C. provides a bacteria killing rate of more than 50% according to the QB/T 2738-2005 method.

The laundry detergent composition herein provides anti-microbial benefits against both gram positive bacteria (e.g., Staphylococcus aureus) and gram negative bacteria (e.g., Escherichia coli). In particular, the laundry detergent composition provides good anti-microbial efficacy against gram positive bacteria.

There are a variety of factors that may determine the level of the free LAS monomers in a laundry washing liquor. Such factors include but are not limited to: CMC of the laundry detergent composition, the level of the LAS in the laundry detergent composition, the presence of co-surfactants and their levels in the laundry detergent composition, the ratio of the LAS to co-surfactants, the presence of adjunct ingredients in the laundry detergent composition, and conditions of the water supplied for the laundry washing liquor (e.g., the water hardness). These factors may affect each other. Thus, by adjusting these factors, a wide variety of combinations between LAS and co-surfactants or other ingredients are suitable herein provided the combinations deliver a free LAS monomer level of more than 60 ppm in a laundry washing liquor.

In one embodiment, the laundry detergent composition herein comprises LAS and is substantially free of a co-surfactant, preferably substantially free of AES, a nonionic surfactant, a cationic surfactant, and a zwitterionic surfactant. Preferably, the laundry detergent composition comprises at least 2.9% of the LAS and is substantially free of a co-surfactant, which delivers a free LAS monomer level of more than 60 ppm in a laundry washing liquor. More preferably, the laundry detergent composition comprises at least 3.2% of the LAS and is substantially free of a co-surfactant, which delivers a free LAS monomer level of more than 67 ppm in a laundry washing liquor. Even more preferably, the laundry detergent composition comprises at least 4.3% of the LAS and is substantially free of a co-surfactant, which delivers a free LAS monomer level of more than 88 ppm in a laundry washing liquor.

In an alternative embodiment, the laundry detergent composition further comprises a co-surfactant selected from the group consisting of an anionic surfactant except the LAS (e.g., AES), a nonionic surfactant, a cationic surfactant, a zwitterionic surfactant, and a combination thereof. Without wishing to be bound by theory, with the introduction of the co-surfactant, the CMC of the laundry detergent composition is significantly reduced and surfactants start to form micelles at a lower concentration. As a result, the amount of the left free LAS monomers is reduced. Therefore, in order to achieve a free LAS monomer level of more than 60 ppm, the level of the LAS in the laundry detergent composition having such a surfactant system needs to be slightly higher than the aforementioned laundry detergent composition that is free of a co-surfactant.

In one preferred embodiment, the laundry detergent composition comprises the combination of LAS and a co-surfactant of AES. Preferably, the AES is present at a level of from 0.001% to 53.6%, preferably from 0.001% to 25.5%, by weight of the composition. For example, in a laundry washing liquor, a laundry detergent composition having the LAS at a level of 3.9% and the AES at a level of 5.0% delivers a free LAS monomer of 60 ppm, a laundry detergent composition having the LAS at a level of 4.6% and the AES at a level of 5.0% delivers a free LAS monomer of 67 ppm, a laundry detergent composition having the LAS at a level of 20.0% and the AES at a level of 25.5% delivers a free LAS monomer of 88 ppm, and a laundry detergent composition having the LAS at a level of 20.0% and the AES at a level of 44.5% delivers a free LAS monomer of 67 ppm. A relatively low level of the AES in the laundry detergent composition is preferred as it requires a lower level of the LAS to achieve the free LAS monomer level of more than 60 ppm in a laundry washing liquor.

In another preferred embodiment, the laundry detergent composition comprises the combination of LAS and a co-surfactant of nonionic surfactant. Preferably, the nonionic surfactant is present at a level of from 0.001% to 25.4%, preferably from 0.001% to 13.5%, by weight of the composition. For example, in a laundry washing liquor, a laundry detergent composition having the LAS at a level of 3.5% and the nonionic surfactant at a level of 0.6% delivers a free LAS monomer of 60 ppm, a laundry detergent composition having the LAS at a level of 4.0% and the nonionic surfactant at a level of 0.6% delivers a free LAS monomer of 67 ppm, a laundry detergent composition having the LAS at a level of 20.0% and the nonionic surfactant at a level of 13.5% delivers a free LAS monomer of 88 ppm, and a laundry detergent composition having the LAS at a level of 20.0% and the nonionic surfactant at a level of 21.7% delivers a free LAS monomer of 67 ppm. Similar to the AES, a relatively low level of the nonionic surfactant in the laundry detergent composition is preferred as it requires a lower level of the LAS to achieve the free LAS monomer level of more than 60 ppm in a laundry washing liquor.

In yet another preferred embodiment, the laundry detergent composition comprises the combination of LAS and co-surfactants of AES and nonionic surfactant. Preferably, the nonionic surfactant is present at a level of from 0.001% to 25.4%, preferably from 0.001% to 13.5%, the AES is present at a level of from 0.001% to 53.6%, preferably from 0.001% to 25.5%, by weight of the composition, and the laundry detergent composition delivers a free LAS monomer level of more than 67 ppm in a laundry washing liquor. For example, in a laundry washing liquor, a laundry detergent composition having the LAS at a level of 11.5%, the AES at a level of 8.2%, and the nonionic surfactant at a level of 0.2% delivers a free LAS monomer of 97 ppm.

The laundry detergent composition herein may be acidic or alkali or pH neutral, depending on the ingredients incorporated in the composition. The pH range of the laundry detergent composition is preferably from 5 to 11. It is known that an acidic or alkali laundry detergent composition achieves better anti-microbial efficacy than a pH neutral laundry detergent composition. Thus, the laundry detergent composition of the present invention that delivers a free LAS monomer level of more than 60 ppm in a laundry washing liquor achieves even better anti-microbial efficacy under either acidic or alkali conditions versus under a neutral pH condition.

The laundry detergent composition may be a liquid or granular laundry detergent composition, preferably is a liquid laundry detergent composition. The term “liquid laundry detergent composition”, as used herein, refers to compositions that are in a form selected from the group consisting of pourable liquid, gel, cream, and combinations thereof. The liquid laundry detergent composition may be anisotropic, isotropic and combinations thereof.

Anionic Surfactant

LAS is a required anionic surfactant for the laundry detergent composition of the present invention. The LAS herein can be any LAS classes known in the art. C₁₀-C₁₆ LAS is preferred. The LAS is normally prepared by sulfonation (using SO₂ or SO₃) of alkylbenzenes followed by neutralization. Suitable alkylbenzene feedstocks can be made from olefins, paraffins or mixtures thereof using any suitable alkylation scheme, including sulfuric and HF-based processes. By varying the precise alkylation catalyst, it is possible to widely vary the position of covalent attachment of benzene to an aliphatic hydrocarbon chain. Accordingly the LAS herein can vary widely in 2-phenyl isomer and/or internal isomer content.

In addition to the LAS, non-limiting examples of anionic surfactants useful as a co-surfactant herein include: C₁₀-C₂₀ primary, branched-chain and random alkyl sulfates (AS); C₁₀-C₁₈ secondary (2,3) alkyl sulfates; AES, preferably C₁₀-C₁₈ alkyl alkoxy sulfates (AE_{X}S) wherein preferably x is from 1-30, more preferably x is 1-3; C₁₀-C₁₈ alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, and WO 99/05244; methyl ester sulfonate (MES); and alpha-olefin sulfonate (AOS). AES is the preferred anionic surfactant as a co-surfactant.

Nonionic Surfactant

Non-limiting examples of nonionic surfactants include: C12-C18 alkyl ethoxylates, such as Neodol® nonionic surfactants available from Shell; C6-C12 alkyl phenol alkoxylates wherein the alkoxylate units are a mixture of ethyleneoxy and propyleneoxy units; C12-C18 alcohol and C6-C12 alkyl phenol condensates with ethylene oxide/propylene oxide block alkyl polyamine ethoxylates such as PLURONIC® available from BASF; C14-C22 mid-chain branched alcohols, BA, as discussed in U.S. Pat. No. 6,150,322; C14-C22 mid-chain branched alkyl alkoxylates, BAEx, wherein x is from 1-30, as discussed in U.S. Pat. No. 6,153,577, U.S. Pat. No. 6,020,303 and U.S. Pat. No. 6,093,856; alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408. Also useful herein as nonionic surfactants are alkoxylated ester surfactants such as those having the formula R1C(O)O(R2O)nR3 wherein R1 is selected from linear and branched C6-C22 alkyl or alkylene moieties; R2 is selected from C2H4 and C3H6 moieties and R3 is selected from H, CH3, C2H5 and C3H7 moieties; and n has a value between 1 and 20. Such alkoxylated ester surfactants include the fatty methyl ester ethoxylates (MEE) and are well-known in the art; see for example U.S. Pat. No. 6,071,873; U.S. Pat. No. 6,319,887; U.S. Pat. No. 6,384,009; U.S. Pat. No. 5,753,606; WO 01/10391, WO 96/23049. The preferred nonionic surfactant as a co-surfactant is C12-C115 alcohol ethoxylated with 7 moles of ethylene oxide (e.g., Neodol®25-7 available from Shell).

Cationic Surfactant

Non-limiting examples of cationic surfactants include: the quaternary ammonium surfactants, which can have up to 26 carbon atoms include: alkoxylate quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660, 4,260,529 and U.S. Pat. No. 6,022,844; and amino surfactants as discussed in U.S. Pat. No. 6,221,825 and WO 00/47708, specifically amido propyldimethyl amine (APA).

Adjunct Ingredients

The laundry detergent composition herein may comprise adjunct ingredients. Suitable adjunct materials include but are not limited to: builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, perfumes, structure elasticizing agents, fabric softeners, carriers, hydrotropes, processing aids, solvents, hueing agents, structurants and/or pigments. In addition to the disclosure below, suitable examples of such other adjuncts and levels of use are found in U.S. Pat. Nos. 5,576,282, 6,306,812 B1 and 6,326,348 B1 that are incorporated by reference. The precise nature of these adjunct ingredients and the levels thereof in the laundry detergent composition will depend on the physical form of the composition and the nature of the cleaning operation for which it is to be used.

The laundry detergent composition herein may or may not comprise an anti-microbial agent. Preferably, the laundry detergent composition is substantially free of an anti-microbial agent. Without the incorporation of an anti-microbial agent, the laundry detergent composition avoids the issues caused by anti-microbial agents, e.g., formulation stability, skin irritation. Nevertheless, it should be understood and appreciated that the anti-microbial agent can be incorporated into the laundry detergent composition in certain circumstances, e.g., to kill a particular type of bacteria.

### Container

The laundry detergent product of the present invention comprises a container containing the laundry detergent composition, wherein the container comprises instructions instructing the user of the anti-microbial benefit of the laundry detergent composition. Non-limiting examples of the instructions include: anti-microbial detergent, bacteria killing, bacteria removal, and the like. In one embodiment, the container comprises instructions instructing the user of the anti-microbial benefit of the laundry detergent composition against gram positive bacteria.

The container herein can be of any suitable size known in the art. In one embodiment, the container is configured to have an internal volume of from 250 cm³ to 10,000 cm³, preferably from 500 cm³ to 3,000 cm³.

The container can be made of any suitable material, such as glass, metal, polymer, and the like. In one embodiment, the container is made of a polymeric material selected from the group consisting of polypropylene (PP), polyethylene (PE), polycarbonate (PC), polyamides (PA) polyethylene terephthalate (PET), polyvinylchloride (PVC), polystyrene (PS), and a combination thereof.

The container herein can be of any form known in the art, such as bottle, box, bag, and pouch. In one embodiment, the laundry detergent composition is a liquid laundry detergent composition, and the container is a bottle. Preferably, the container is a bottle comprising a dosing cap, wherein the dosing cap is configured to hold a volume of from 30 g to 150 g, preferably from 60 g to 120 g.

Preferably, the container further comprises instructions instructing the user to dose a suitable amount of the laundry detergent composition, depending on factors including the nature and the amount of the fabrics or surfaces that are going to be cleaned, the washing type, the amount of water used for cleaning, etc. For example, the instructions instruct the user to dose from 5 g to 60 g of the laundry detergent composition into a hand washing basin (e.g., 4 L) or from 60 g to 120 g of the laundry detergent composition into a washing machine (e.g., 30 L). In the execution of the bottle comprising a dosing cap, the instructions instruct the user to dose from 5 g to 60 g of the laundry detergent composition into a hand washing basin or from 60 g to 120 g of the laundry detergent composition into a washing machine via the dosing cap.

The container may further comprise instructions instructing the user to use the laundry detergent composition for a hand washing. In particular, when the laundry detergent composition is substantially free of an anti-microbial agent, the container comprises instructions instructing the user to use the laundry detergent composition for a hand washing. For example, such instructions could be: gentle to the skin, not harsh to your hand, and the like.

The container may further comprise instructions instructing the user to wash a fabric with the laundry detergent composition for certain time, preferably from 1 minute to 90 minutes, more preferably from 3 minutes to 60 minutes, even more preferably from 20 minutes to 50 minutes, alternatively at least 20 minutes. For example, such instructions could be: wash your fabric with the laundry detergent composition for at least 20 minutes to deliver a better anti-microbial benefit.

The container may further comprise instructions instructing the user to pre-treat a fabric with the laundry detergent composition for certain time, preferably from 1 minute to 10 minutes.

The instructions herein may be applied to, preferably printed onto, any portions of the outward facing side of the container, e.g., the front, the back, the side, the cap. In one embodiment, the instructions related to the anti-microbial benefit are applied to the front of the container, and the instructions related to the dosing amount are applied to the back of the container.

### Composition Preparation

The laundry detergent composition of the present invention is generally prepared by conventional methods such as those known in the art of making laundry detergent compositions. Such methods typically involve mixing the essential and optional ingredients in any desired order to a relatively uniform state, with or without heating, cooling, application of vacuum, and the like, thereby providing laundry detergent compositions containing ingredients in the requisite concentrations.

### The Use

One aspect of the present invention is directed to the use of the laundry detergent composition for providing an anti-microbial benefit. The laundry detergent composition comprises at least 2.9%, preferably from 3.2% to 30%, more preferably from 4.3% to 20%, by weight of the composition, of a LAS, wherein the laundry detergent composition is capable of delivering a free LAS monomer level of more than 60 ppm, preferably from 67 ppm to 500 ppm, more preferably from 88 ppm to 300 ppm, in a laundry washing liquor.

Preferably, the anti-microbial benefit is determined by the QB/T 2738-2005 method. More preferably, the laundry detergent composition provides a bacteria killing rate of at least 50% in a 2069 ppm aqueous solution against Staphylococcus aureus for a 20 minutes contact time as determined by the QB/T 2738-2005 method. In one preferred embodiment, the laundry detergent composition comprises at least 2.9%, by weight of the composition, of a LAS, is capable of delivering a free LAS monomer level of more than 60 ppm in a laundry washing liquor, and provides a bacteria killing rate of at least 50% in a 2069 ppm aqueous solution having a temperature of above 35° C. against Staphylococcus aureus for a 20 minutes contact time as determined by the QB/T 2738-2005 method. In an alternative embodiment, the laundry detergent composition comprises from 3.2% to 30%, by weight of the composition, of a LAS, is capable of delivering a free LAS monomer level of from 67 ppm to 300 ppm in a laundry washing liquor, and provides a bacteria killing rate of at least 50% in a 2069 ppm aqueous solution against Staphylococcus aureus for a 20 minutes contact time as determined by the QB/T 2738-2005 method. In a more preferred embodiment, the laundry detergent composition comprises from 4.3% to 20%, by weight of the composition, of a LAS, is capable of delivering a free LAS monomer level of from 88 ppm to 300 ppm in a laundry washing liquor, and provides a bacteria killing rate of at least 90% in a 2069 ppm aqueous solution against Staphylococcus aureus for a 20 minutes contact time as determined by the QB/T 2738-2005 method.

### Method of Use

Another aspect of the present invention is directed to a method of using the laundry detergent product to treat a fabric with an anti-microbial benefit. The method comprises the step of administering from 5 g to 120 g of the laundry detergent composition into a laundry washing basin comprising water to form an aqueous solution, wherein the aqueous solution has a free LAS monomer level of more than 60 ppm, preferably from 67 ppm to 500 ppm, more preferably from 88 ppm to 300 ppm. The aqueous solution in a laundry washing basin herein has the same volume as the laundry washing liquor, preferably from 1 L to 50 L, alternatively from 1 L to 20 L for hand washing and from 20 L to 50 L for machine washing. The required dosing amount of the laundry detergent composition by the present invention, namely, from 5 g to 120 g of the laundry detergent composition, is capable of delivering a free LAS monomer level of more than 60 ppm in a laundry washing liquor of from 1 L to 50 L. Preferably, the anti-microbial benefit herein is determined by the QB/T 2738-2005 method. The temperatures of the laundry washing liquor preferably range from 5° C. to 60° C.

The dosing amount in the method herein may be different depending on the washing type. In one embodiment, the method comprises administering from 5 g to 60 g of the laundry detergent composition into a hand washing basin (e.g., 4 L). In an alternative embodiment, the method comprises administering from 60 g to 120 g of the laundry detergent composition into a washing machine (e.g., 30 L).

Preferably, the method herein further comprises the step of contacting a fabric with the aqueous solution, wherein the fabric is in need of an anti-microbial treatment. For example, the presence of gram positive bacteria and/or gram negative bacteria is suspected on the fabric. The step of contacting the fabric with the aqueous solution is preferably after the step of administering the laundry detergent composition in a laundry washing basin. The method may further comprise the step of contacting a fabric with the laundry detergent composition prior to the step of administering the laundry detergent composition in a laundry washing basin, i.e., pre-treat the fabric with the laundry detergent composition for certain time, preferably from 1 minute to 10 minutes.

### Calculation Method of Free LAS Monomer

The calculation model of CMC and monomer-micelle composition is based on the Pseudo-phase Separation Model and the Regular Solution Theory. The Pseudo-phase Separation Model is described in “Non-ideal multicomponent mixed micelle model”, Holland, P. M.; Rubingh, D. N., J. Phys. Chem. 1983, 87 (11), 1984-1990. The Regular Solution Theory is described in “Micellization of mixed nonionic surface-active agents”, Clint J. H., J. Chem. Soc., Faraday Trans. 1 1975, 71, 1327-1334. The inputs to the calculation model are the composition of the surfactant formulation, CMCs of individual surfactants, and the interaction between the surfactants in a mixed micelle (i.e., beta parameters).

The Pseudo-phase Separation Model is used to calculate the CMC of a surfactant mixture. In this model, above the CMC the surfactants are assumed to exist in two phases in equilibrium with each other: aggregated micellar phase and non-aggregated monomeric phase. Based on this two phase approximation, the chemical potential of a given surfactant species in each phase can be calculated as:

For monomeric phase, μᵢ^{mon}=μᵢ^{0,mon}+RT ln Cᵢ^{mon} (1)

For micellar phase, μᵢ^{mic}=μᵢ^{0,mic}+RT ln xᵢγᵢ (2)

Also, for a pure surfactant solution at and above its CMC, the monomer concentration is fixed equal to the CMC concentration. Since the solution and micelle chemical potentials are equal, the following relationship is established for a pure system:

μᵢ^{mic}=μᵢ^{0,mon}+RT ln Cᵢ^{CMC} (3)

At equilibrium, the chemical potential for a given species is equal in the two phases, i.e., (1)=(2). Therefore, obtain the following relationship by combining equations (1), (2) and (3):

Cᵢ^{mon}=xᵢγᵢCᵢ^{CMC} (4)

For the mixture CMC, the following relationship is valid:

Cᵢ^{mon}=αᵢCₘᵢₓₜᵤᵣₑ^{CMC} (5)

Combining equations (4) and (5), and summing over the species, the CMC of the mixture is calculated as:

$${C}_{mixture}^{CMC} = {( {\sum }_{i = 1}^{n} \frac{{α}_{i}}{{C}_{i}^{CMC} {γ}_{i}} )}^{- 1} \qquad ( 6 )$$

In order to calculate the activity coefficient, γi in equation (6), the Regular Solution Theory is referred to. From the Regular Solution Theory, a simple activity coefficient model is derived as:

$$ln {γ}_{i} = {\sum }_{{j = 1}_{( j \neq i )}}^{n} {β}_{ij} {x}_{j}^{2} + {\sum }_{{j = 1}_{( j \neq i \neq k )}}^{n} {\sum }_{k = 1}^{j - 1} ( {β}_{ij} + {β}_{ik} - {β}_{jk} ) {x}_{j} {x}_{k} \qquad ( 7 )$$

The Regular Solution Theory allows specific interactions between types of surfactants to be coarsely but successfully captured by a single interaction parameter. Quite often in real surfactant mixtures, the beta parameter is negative representing synergistic interactions between surfactants.

In “Surfactants and Interfacial Phenomena”, Rosen, M. J., Wiley Interscience: New York, 1989, the beta parameters are clustered into groups based on surfactant type, as summarized in Table 1.

TABLE 1

| | | | | ZWITTER- |
|---|---|---|---|---|
| | ANIONIC | CATIONIC | NONIONIC | IONIC |
| ANIONIC | 0 | −8 | −2 | −4 |
| CATIONIC | −8 | 0 | −2 | −4 |
| NONIONIC | −2 | −2 | 0 | 0 |
| ZWITTERIONIC | −4 | −4 | 0 | 0 |

To calculate the non-ideal mixture CMC, combine equation (7) with the following equations and solve iteratively.

Rewrite equation (4) for species i and j,

$$\frac{{x}_{i}}{{x}_{j}} = \frac{{α}_{i} {C}_{j}^{CMC} {γ}_{j}}{{α}_{j} {C}_{i}^{CMC} {γ}_{i}} \qquad ( 8 )$$

Sum over species j in equation (8),

$$\frac{1}{{x}_{i}} - {\sum }_{j \neq i} \frac{{α}_{j} {C}_{i}^{CMC} {γ}_{i}}{{α}_{i} {C}_{j}^{CMC} {γ}_{j}} = 1 \qquad ( 9 )$$

Equations (7), (8) and (9) are then iteratively solved starting with an estimate value for activity coefficients. Specifically, steps involved in iterations include:

1) Initially, make an estimate of the activity coefficients. One option is to start by assuming an ideal micelle, where all activity coefficients are unity.

2) Based on a set of activity coefficients, solve (9) to calculate a new estimate of micelle mole fraction for a reference component, xᵢ. Use xᵢ with (8) to calculate new estimates for remaining micelle components.

3) Use the new micelle compositions with (7) to generate new activity coefficients. If the old and new activity coefficients have converged then a self-consistent solution is achieved. Otherwise, return to step 2 and continue to iterate until convergence.

Once the non-ideal CMC is known, the next step is to calculate the amount of each species present as monomers and in micelles. Below the CMC, the system is present fully as monomers, and the monomer concentrations are equal to the bulk values. Above the CMC, the following relationship is needed to relate the micelle mole fraction of a given species to a reference species:

$${x}_{j} = \frac{{α}_{j} {C}^{total}}{{C}_{j}^{CMC} {γ}_{j} - {C}_{i}^{CMC} {γ}_{i} + {α}_{i} {C}^{total} / {x}_{i}} \qquad ( 10 )$$

The following relationship is based on the constraint that mole fractions sum to one:

$$\frac{1}{{x}_{i}} - {\sum }_{j \neq i} \frac{{x}_{j}}{{x}_{i}} = 1 \qquad ( 11 )$$

Substituting (10) into (11) yields an expression to solve for reference mole fraction xᵢ based on an estimate of activity coefficients. Therefore, the same solution steps as used for non-ideal CMC can be used, except (10)-(11) take the place of (8)-(9). Once micelle mole fractions and activity coefficients have been self-consistently determined, (4) is used to yield monomer concentrations.

Wherein in the above equations (1) to (11):

| Symbol | Meaning |
|---|---|
| Cᵢ^{CMC} | critical micelle concentration of pure component i |
| Cₘᵢₓₜᵤᵣₑ^{CMC} | critical micelle concentration of mixed system |
| Cᵢ^{mon} | concentration of species i present as monomer |
| C^{total} | total concentration of all species in overall mixed system |
| xᵢ | mole fraction of species i in mixed micelle |
| Xᵢ | mole fraction of a class of species i, in mixed micelle |
| αᵢ | mole fraction of species i in overall mixed system |
| βᵢⱼ | interaction parameter between species or species classes i |
| | and j in mixed |
| γᵢ | activity coefficient for species i in mixed micelle |
| μᵢ^{0, mon} | standard chemical potential of species i in monomeric state |
| μᵢ^{0, mic} | standard chemical potential of species i in pure micelle |
| μᵢ^{mon} | chemical potential of species i as monomer in solution |
| μᵢ^{mic} | chemical potential of species i in mixed micelle |

Therefore, for a surfactant mixture or an aqueous solution comprising LAS, the level of the free LAS monomers can be calculated as described above, wherein species i represents LAS and species j and k represent one or more co-surfactants.

### Test Method

The anti-microbial efficacy for laundry detergent compositions is determined by the method of simulation of washing machine as defined in the QB/T 2738-2005 method.

1. Microorganism Preparation:

A. Aseptically add certain amount of nutrient broth into a lyophilized culture of Staphylococcus aureus. Dissolve and suspend the culture in the nutrient broth to obtain a suspension. Apply some of the suspension into a tube containing 5.0 mL to 10.0 mL of nutrient broth, and incubate at 37° C. for 18 hours to 24 hours to obtain a first generation subculture of bacterial suspension. Streak a loop of the first generation subculture of bacterial suspension on a nutrient agar plate, and incubate at 37° C. for 18 hours to 24 hours to obtain a second generation subculture of bacterial suspension. Inoculate a colony of the second generation subculture of bacterial suspension on a nutrient agar slant, incubate at 37° C. for 18 hours to 24 hours to obtain a third generation subculture of bacterial suspension.

B. Use 3.0 mL to 5.0 mL of a dilution to purge colonies of the third generation subculture to the fourteenth generation subculture of bacterial suspension on a nutrient agar slant. Transfer the purge solution into another sterile tube, and vortex to mix for 20 seconds or shake with hand for 80 times to obtain a preliminary working culture.

C. Adjust the bacterial concentration of the preliminary working culture to the required bacterial concentration with Spectrophotometer to obtain a working culture.

D. Store the working culture at 4° C. The working culture cannot be stored overnight.

2. Assay Protocol:

A. Boil 300 g of a test fabric (32 yarn/cm×32 yarn/cm, plain weave cotton) in 3 L of a washing solution for 1 hour. The washing solution is prepared by 1.5 g of a nonionic soaked agent, 1.5 g of sodium carbonate, and 3000 mL of distilled water. The nonionic soaked agent is prepared by 5.0 g of alkylphenol ethoxylate, 5 g of sodium carbonate, and 1000 mL of distilled water. Rinse the test fabric in boiled deionized water for 5 minutes. Place the test fabric in cool deionized water for 5 minutes, and indoor dry.

B. Cut the treated test fabric to a strip having a width of 5 cm width and weight of 15±1 g. Fix one end of the test fabric strip onto a stainless steel spindle at an outer position along the horizontal extension of the stainless steel spindle. The stainless steel spindle has 3 horizontal stands that are connected to one another. Wrap the test fabric strip around the 3 horizontal stands of the stainless steel spindle with sufficient tension to obtain a fabric wrapped spindle having 12 laps of fabric. Fix the other end of the test fabric strip onto the outer lap of the 12 laps of fabric via a pin. Sterilize the fabric wrapped spindle with pressure steam at 121° C. for 15 minutes.

C. Dilute the working culture obtained from step 1D using a phosphate buffered solution (PBS) to achieve a concentration of from 1×10⁴ cfu/ml to 9×10⁴ cfu/ml. Add a bovine serum albumin solution (BSA) with the same volume to obtain a bacterial suspension. The PBS is prepared by dissolving 2.83 g of disodium hydrogen phosphate, anhydrous and 1.36 g of potassium dihydrogen phosphate in 1000 mL of distilled water, until completely dissolved adjusting the pH of the solution to 7.2 to 7.4, and then sterilizing the solution with pressure steam at 121° C. for 20 minutes. The BSA is prepared by dissolving 3.0 g bovine serum albumin in 100 mL of distilled water, filtered the solution with a microporous membrane having a pore size of 0.45 μm and preserved in a refrigerator.

D. Prepare 3 fabric carriers, each fabric carrier having a width of 2.5 cm to 3.8 cm. Treat the fabric carriers with the same method as treating the test fabric, as described herein above in step 2A. Inoculate each fabric carrier with 20 μL of the bacterial suspension obtained from step 2C. Place the inoculated fabric carrier in a petri dish with cover. Dry the inoculated fabric carriers in an incubator at (35±2)° C. for 20 minutes.

E. 20 minutes prior to testing, place an exposure chamber containing 265 mL of standard hard water in a water bath to achieve the test temperature of (25±1)° C. The exposure chamber is sterilized with pressure steam at 121° C. for 15 minutes. The standard hard water is prepared by dissolving 0.034 g of calcium chloride and 0.139 g of magnesium chloride hexahydrate in 1000 mL of distilled water, and then sterilizing the solution with pressure steam at 121° C. for 20 minutes. Add sufficient amount of sample into the exposure chamber to obtain a mixed solution having a concentration of 2069 ppm.

F. Place the 2 inoculated fabric carriers in the position between the 6^{th} lap and the 7^{th} lap of the 12 laps of fabric, and place the 3^{rd} inoculated fabric carrier into the position between the 7^{th} lap and the 8^{th} lap of the 12 laps of fabric.

G. Aseptically place the spindle unit (including the fabric wrapped spindle and the inoculated fabric carriers) into the exposure chamber, and close the exposure chamber with a lid.

H. Fix the exposure chamber onto a shaker. Rotate the shaker for 20 minutes. Remove the exposure chamber from the shaker.

I. Aseptically remove the spindle unit out of the exposure chamber and remove the 3 inoculated fabric carriers from the fabric wrapped spindle. Place each fabric carrier into a separate tube containing 30 mL of a neutralizer, vortex to mix for 10 seconds, shake for 100 times, and 10 times serially dilute using PBS. The neutralizer is prepared by 37.8 g of letheen broth base modified (available as 110405 from Merck), 30 g of Tween 80, 2.3 g of lecithin, 5 g of sodium thiosulfate, and 1000 mL of distilled water. Tween 80 is polyoxyethylene (20) sorbitan monooleate. Plate appropriate dilution of the sample into TSB with duplicate form a TSB plate.

J. In step 2E, use a PBS containing 0.5% Tween 80 instead of the sample as control.

K. Incubate the TSB plates of the sample and the control reversely in a incubator at (35±2)° C. for (48±4) hours. Plate counting.

L. Repeat 3 times, and obtain average results.

3. Calculation of Bacteria Killing Rate

Bacteria Killing Rate (%)=(A−B)/A×100%

wherein: A: Counting of control group
B: Counting of sample group

A Bacteria Killing Rate of greater than 50% represents acceptable anti-microbial efficacy, of greater than 90% represents good anti-microbial efficacy, and of greater than 99% represents excellent anti-microbial efficacy. And a Bacterial Killing Rate of lower than 50% indicates unacceptable poor anti-microbial efficacy.

### EXAMPLE

The Examples herein are meant to exemplify the present invention but are not used to limit or otherwise define the scope of the present invention. Examples 1A-1X and 2A-2D are examples according to the present inventions, and Examples 3A-3B are comparative examples.

### Example 1A-1X

### Formulations of Laundry Detergent Compositions

The following compositions in liquid forms shown in Table 2 are made comprising the listed ingredients in the listed proportions (weight %). The calculated level of the free LAS monomers in a 2069 ppm aqueous solution according to the Calculation Method of Free LAS Monomer as described above is listed for each composition.

TABLE 2

| | 1A | 1B | 1C | 1D | 1E | 1F | 1G | 1H |
|---|---|---|---|---|---|---|---|---|
| C₁₁-C₁₃ LAS | 2.9 | 3.2 | 4.3 | 11 | 3.9 | 4.6 | 7.3 | 4.5 |
| C₁₂-C₁₄AE₃S | 0 | 0 | 0 | 0 | 5.0 | 5.0 | 5.0 | 1.0 |
| Neodol ® 25-7 a | 0 | 0 | 0 | 0 | 0 | 0 | 0 | 0 |
| Water | Add to | Add to | Add to | Add to | Add to | Add to | Add to | Add to |
| | 100 | 100 | 100 | 100 | 100 | 100 | 100 | 100 |
| Free LAS | 60 | 67 | 88 | 133 | 60 | 67 | 88 | 88 |
| monomer (ppm) | | | | | | | | |
| | 1I | 1J | 1K | 1L | 1M | 1N | 1O | 1P |
| C₁₁-C₁₃ LAS | 3.7 | 20.0 | 20.0 | 30.0 | 3.5 | 4.0 | 7.9 | 5.6 |
| C₁₂-C₁₄AE₃S | 1.0 | 53.6 | 44.5 | 25.5 | 0 | 0 | 0 | 0 |
| Neodol ® 25-7 a | 0 | 0 | 0 | 0 | 0.6 | 0.6 | 5.0 | 0.6 |
| Water | Add to | Add to | Add to | Add to | Add to | Add to | Add to | Add to |
| | 100 | 100 | 100 | 100 | 100 | 100 | 100 | 100 |
| Free LAS | 76 | 60 | 67 | 88 | 60 | 67 | 67 | 88 |
| monomer (ppm) | | | | | | | | |
| | 1Q | 1R | 1S | 1T | 1U | 1V | 1W | 1X |
| C₁₁-C₁₃LAS | 11.3 | 20.0 | 20.0 | 20.0 | 6.5 | 9.0 | 11.0 | 11.5 |
| C₁₂-C₁₄AE₃S | 0 | 0 | 0 | 0 | 9.8 | 7.0 | 5.5 | 8.2 |
| Neodol ® 25-7 a | 5.0 | 25.4 | 21.7 | 13.5 | 1.4 | 0.6 | 0.6 | 0.2 |
| Water | Add to | Add to | Add to | Add to | Add to | Add to | Add to | Add to |
| | 100 | 100 | 100 | 100 | 100 | 100 | 100 | 100 |
| Free LAS | 88 | 60 | 67 | 88 | 60 | 87 | 101 | 97 |
| monomer (ppm) | | | | | | | | |

a Neodol ® 25-7 is C12-C115 alcohol ethoxylated with 7 moles of ethylene oxide as a nonionic surfactant, available from Shell

### Preparation of the Compositions of Example 1A-1X

The compositions of Example 1A-1X are prepared by mixing the ingredients listed for each composition with a shear of 250 rpm, respectively.

### Example 2A-2D

### Formulations of Laundry Detergent Compositions

The following compositions in liquid forms shown in Table 3 are made comprising the listed ingredients in the listed proportions (weight %). The calculated level of the free LAS monomers in a 2069 ppm aqueous solution according to the Calculation Method of Free LAS Monomer as described above is listed for each composition.

TABLE 3

| | 2A | 2B | 2C | 2D |
|---|---|---|---|---|
| C₁₁-C₁₃ LAS | 9.0 | 11.0 | 11.5 | 6.5 |
| C₁₂-C₁₄AE₃S | 7.0 | 8.0 | 8.2 | 9.8 |
| Neodol ®25-7 a | 0.6 | 0.6 | 0.2 | 1.4 |
| Citric acid | 1 | 0.5 | 0 | 2.4 |
| C₁₂-C₁₈ fatty acid | 1.2 | 1.3 | 0 | 1.3 |
| Chelant b | 0.2 | 0.4 | 0 | 0.4 |
| 1,2 propanediol | 2 | 4 | 0 | 2.5 |
| Tri ethanol amine | 0 | 0 | 1.8 | 0 |
| NaOH | 2.9 | 2.9 | 0 | 3.2 |
| Dye | 0.002 | 0.002 | 0.002 | 0.002 |
| Perfume | 0.5 | 0.7 | 0.5 | 0.5 |
| Water | Add | Add | Add | Add |
| | to 100 | to 100 | to 100 | to 100 |
| Free LAS monomer (ppm) | 87 | 93 | 97 | 60 |

a Neodol ®25-7 is C12-C115 alcohol ethoxylated with 7 moles of ethylene oxide as a nonionic surfactant, available from Shell
b diethylene triamine penta acetate

### Preparation of the Composition of Example 2A

The composition of Example 2A is prepared by the following steps:
a) mixing a combination of NaOH, 1, 2 propanediol, and water in a mixer by applying a shear of 200 rpm;
b) adding Citric acid, Neodol®25-7, and Chelant in sequence into the combination obtained in step a), keeping on mixing by applying a shear of 200 rpm;
c) increasing the mixing shear to 250 rpm, and maintaining the temperature of the combination obtained in step b) to be under 45° C.;
d) mixing the combination obtained in step c) with LAS by applying a shear of 250 rpm;
e) once the temperature of the combination obtained in step d) is below 35° C., adding AES into the combination and mixing by applying a shear of 250 rpm until the combination is homogeneously mixed;
f) adding C₁₂-C₁₈ fatty acid into the combination obtained in step e), keeping on mixing by applying a shear of 250 rpm for 5 minutes;
g) adding Perfume and Dye into the combination obtained in step f), keeping on mixing by applying a shear of 250 rpm for 5 minutes, thus forming a liquid laundry detergent composition,

wherein in the composition, each ingredient is present in the amount as specified for Example 2A in Table 3.

### Preparation of the Composition of Example 2B

The composition of Example 2B is prepared by the same steps as preparing the composition of Example 2A, except for that each ingredient is present in the amount as specified for Example 2B in Table 3.

### Preparation of the Composition of Example 2C

The composition of Example 2C is prepared by the following steps:
a) mixing a combination of Tri ethanol amine and water in a mixer by applying a shear of 200 rpm;
b) adding Neodol®25-7 into the combination obtained in step a), keeping on mixing by applying a shear of 200 rpm;
c) increasing the mixing shear to 250 rpm, and maintaining the temperature of the combination obtained in step b) to be under 45° C.;
d) mixing the combination obtained in step c) with LAS by applying a shear of 250 rpm;
e) once the temperature of the combination obtained in step d) is below 35° C., adding AES into the combination and mixing by applying a shear of 250 rpm until the combination is homogeneously mixed;
f) adding Perfume and Dye into the combination obtained in step e), keeping on mixing by applying a shear of 250 rpm for 5 minutes, thus forming a liquid laundry detergent composition,

wherein in the composition, each ingredient is present in the amount as specified for Example 2C in Table 3.

### Preparation of the Composition of Example 2D

The composition of Example 2D is prepared by the same steps as preparing the composition of Example 2A, except for that each ingredient is present in the amount as specified for Example 2D in Table 3.

### Comparative Example 3A-3B

### Comparative Formulations of Laundry Detergent Compositions

The following comparative compositions in liquid forms shown in Table 4 are made comprising the listed ingredients in the listed proportions (weight %). The calculated level of the free LAS monomers in a 2069 ppm aqueous solution according to the Calculation Method of Free LAS Monomer as described above is listed for each composition.

TABLE 4

| | 3A | 3B |
|---|---|---|
| C₁₁-C₁₃ LAS | 1.9 | 6.0 |
| C₁₂-C₁₄AE₁₋₃S | 11.3 | 9.0 |
| Neodol ®25-7 a | 1.2 | 7.0 |
| Citric acid | 1.4 | 1.7 |
| C₁₂-C₁₈ fatty acid | 1.2 | 1.7 |
| Chelant b | 0.2 | 0 |
| 1,2 propanediol | 1.2 | 1.2 |
| Tri ethanol amine | 0 | 1.3 |
| NaOH | 2.5 | 2.0 |
| Dye | 0.002 | 0.002 |
| Perfume | 0.5 | 0.5 |
| Water | Add | Add |
| | to 100 | to 100 |
| Free LAS monomer (ppm) | 20 | 40 |

a Neodol ®25-7 is C12-C115 alcohol ethoxylated with 7 moles of ethylene oxide as a nonionic surfactant, available from Shell
b diethylene triamine penta acetate

### Preparation of the Composition of Comparative Example 3A

The composition of Comparative Example 3A is prepared by the following steps:
a) mixing a combination of NaOH, 1, 2 propanediol, and water in a mixer by applying a shear of 200 rpm;
b) adding Citric acid, Neodol®25-7, and Chelant in sequence into the combination obtained in step a), keeping on mixing by applying a shear of 200 rpm;
c) increasing the mixing shear to 250 rpm, and maintaining the temperature of the combination obtained in step b) to be under 45° C.;
d) mixing the combination obtained in step c) with LAS by applying a shear of 250 rpm;
e) once the temperature of the combination obtained in step d) is below 35° C., adding AES into the combination and mixing by applying a shear of 250 rpm until the combination is homogeneously mixed;
f) adding C₁₂-C₁₈ fatty acid into the combination obtained in step e), keeping on mixing by applying a shear of 250 rpm for 5 minutes;
g) adding Perfume and Dye into the combination obtained in step f), keeping on mixing by applying a shear of 250 rpm for 5 minutes, thus forming a liquid laundry detergent composition,

wherein in the composition, each ingredient is present in the amount as specified for Comparative Example 3A in Table 4.

### Preparation of the Composition of Comparative Example 3B

The composition of Comparative Example 3B is prepared by the following steps:
a) mixing a combination of NaOH, 1, 2 propanediol, Tri ethanol amine, and water in a mixer by applying a shear of 200 rpm;
b) adding Citric acid and Neodol®25-7 in sequence into the combination obtained in step a), keeping on mixing by applying a shear of 200 rpm;

c) increasing the mixing shear to 250 rpm, and maintaining the temperature of the combination obtained in step b) to be under 45° C.;
d) mixing the combination obtained in step c) with LAS by applying a shear of 250 rpm;
e) once the temperature of the combination obtained in step d) is below 35° C., adding AES into the combination and mixing by applying a shear of 250 rpm until the combination is homogeneously mixed;
f) adding C₁₂-C₁₈ fatty acid into the combination obtained in step e), keeping on mixing by applying a shear of 250 rpm for 5 minutes;
g) adding Perfume and Dye into the combination obtained in step f), keeping on mixing by applying a shear of 250 rpm for 5 minutes, thus forming a liquid laundry detergent composition,

wherein in the composition, each ingredient is present in the amount as specified for Comparative Example 3B in Table 4.

### Comparative Data of Examples 2 and 3

Comparative experiments of measuring the anti-microbial efficacy of the compositions of Examples 2A-2C and Comparative Examples 3A-3B are conducted, according to the QB/T 2738-2005 method as described herein above. The experimental results are shown in Table 5.

TABLE 5

| Example | Free LAS monomer (ppm) | Bacteria Killing Rate (%) |
|---|---|---|
| 2A | 87 | 93 |
| 2B | 93 | 96 |
| 2C | 97 | 99 |
| 3A | 20 | −50 |
| 3B | 40 | 21 |

As shown in Table 5, the laundry detergent compositions according to the present invention (Examples 2A, 2B, and 2C) demonstrate good anti-microbial efficacy, whereas the comparative compositions (Comparative Examples 3A and 3B) show poor anti-microbial efficacy. Moreover, for the laundry detergent compositions according to the present invention, the degree of the anti-microbial efficacy is correlated to the free LAS monomer level, i.e., a higher level of free LAS monomers in a laundry washing liquor leads to a higher Bacteria Killing Rate.

### Data of Example 2D Under Varying Temperature Conditions

Experiments of measuring the anti-microbial efficacy of the composition of 2D under varying temperature conditions are conducted, according to the QB/T 2738-2005 method as described herein above. The test temperatures in steps 2E to 2H (i.e., the temperature of the standard hard water contained in the exposure chamber) are set to be (25±1)° C., (35±1)° C., and (60±1)° C., respectively. The test temperature of control is the same as the corresponding sample. The experimental results are shown in Table 6.

TABLE 6

| Temperature | Free LAS monomer (ppm) | Bacteria Killing Rate (%) |
|---|---|---|
| 25° C. | 60 | 33 |
| 35° C. | 60 | 72 |
| 60° C. | 60 | 84 |

As shown in Table 6, higher test temperatures (namely, 35° C. and 60° C.) enable a lower level of the free LAS monomers in a laundry washing liquor to achieve acceptable anti-microbial efficacy.

Unless otherwise indicated, all percentages, ratios, and proportions are calculated based on weight of the total composition. All temperatures are in degrees Celsius (° C.) unless otherwise indicated. All measurements made are at 25° C., unless otherwise designated. All component or composition levels are in reference to the active level of that component or composition, and are exclusive of impurities, for example, residual solvents or by-products, which may be present in commercially available sources.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. The use of a laundry detergent composition for providing an anti-microbial benefit, said laundry detergent composition comprising at least 2.9%, preferably from 3.2% to 30%, more preferably from 4.3% to 20%, by weight of the composition, of a linear alkylbenzene sulfonate (LAS), wherein said laundry detergent composition is capable of delivering a free LAS monomer level of more than 60 ppm, preferably from 67 ppm to 500 ppm, more preferably from 88 ppm to 300 ppm, in a laundry washing liquor.

2. The use according to claim 1, wherein said anti-microbial benefit is determined by the QB/T 2738-2005 method.

3. The use according to claim 2, wherein said laundry detergent composition is substantially free of a co-surfactant.

4. The use according to claim 2, wherein said laundry detergent composition further comprises from 0.001% to 25.4%, preferably from 0.001% to 13.5%, by weight of the composition, of a nonionic surfactant.

5. The use according to claim 2, wherein said laundry detergent composition further comprises from 0.001% to 53.6%, preferably from 0.001% to 25.5%, by weight of the composition, of a sulphated fatty alcohol ethoxylate (AES).

6. The use according to claim 2, wherein said laundry detergent composition is substantially free of an anti-microbial agent.

7. The use according to claim 2, wherein said laundry detergent composition provides said anti-microbial benefit against gram positive bacteria.

8. The use according to claim 7, wherein said laundry detergent composition provides a bacteria killing rate of at least 50% in a 2069 ppm aqueous solution against Staphylococcus aureus for a 20 minutes contact time as determined by the QB/T 2738-2005 method.

9. The use according to claim 8, wherein said laundry detergent composition is capable of delivering a free LAS monomer level of more than 60 ppm, and wherein said laundry detergent composition provides a bacteria killing rate of at least 50% in a 2069 ppm aqueous solution having a temperature of above 35° C. against Staphylococcus aureus for a 20 minutes contact time as determined by the QB/T 2738-2005 method.

10. The use according to claim 8, wherein said laundry detergent composition is capable of delivering a free LAS monomer level of more than 67 ppm, and wherein said laundry detergent composition provides a bacteria killing rate of at least 50% in a 2069 ppm aqueous solution against Staphylococcus aureus for a 20 minutes contact time as determined by the QB/T 2738-2005 method.

11. A laundry detergent product comprising a laundry detergent composition contained within a container,
wherein said laundry detergent composition comprises at least 2.9%, preferably from 3.2% to 30%, more preferably from 4.3% to 20%, by weight of the composition, of a LAS, wherein said laundry detergent composition is capable of delivering a free LAS monomer level of more than 60 ppm, preferably from 67 ppm to 500 ppm, more preferably from 88 ppm to 300 ppm, in a laundry washing liquor; and
wherein said container comprises instructions instructing the user of the anti-microbial benefit of said laundry detergent composition.

12. The laundry detergent product according to claim 11, wherein said laundry detergent composition is substantially free of a co-surfactant.

13. The laundry detergent product according to claim 11, wherein said laundry detergent composition further comprises from 0.001% to 25.4%, preferably from 0.001% to 13.5%, by weight of the composition, of a nonionic surfactant.

14. The laundry detergent product according to claim 11, wherein said laundry detergent composition further comprises from 0.001% to 53.6%, preferably from 0.001% to 25.5%, by weight of the composition, of an AES.

15. The laundry detergent product according to claim 11, wherein said laundry detergent composition is substantially free of an anti-microbial agent.

16. The laundry detergent product according to claim 11, wherein said laundry detergent composition is a liquid laundry detergent composition, and wherein said container is a bottle comprising a dosing cap, wherein said dosing cap is configured to hold a volume of from 60 g to 120 g, wherein said container further comprises instructions instructing the user to dose from 5 g to 60 g of said laundry detergent composition into a hand washing basin or from 60 g to 120 g of said laundry detergent composition into a washing machine via said dosing cap.

17. The laundry detergent product according to claim 16, wherein said container further comprises instructions instructing the user to use said laundry detergent composition for a hand washing.

18. The laundry detergent product according to claim 11, wherein said container comprises instructions instructing the user of the anti-microbial benefit of said laundry detergent composition against gram positive bacteria.

19. A method of using the laundry detergent product according to any one of claims 11-18 to treat a fabric with an anti-microbial benefit comprising the step of administering from 5 g to 120 g of said laundry detergent composition into a laundry washing basin comprising water to form an aqueous solution, wherein said aqueous solution has a free LAS monomer level of more than 60 ppm, preferably from 67 ppm to 500 ppm, more preferably from 88 ppm to 300 ppm.

20. The method according to claim 19, further comprising the step of contacting a fabric with said aqueous solution, wherein said fabric is in need of an anti-microbial treatment.
